(19) United States
(12) Patent Application Publication
(10) Pub. No.: US 2025/0287921 A1
(43) Pub. Date: Sep. 18, 2025

(54) AIR CONTROLLED PET TOY

(71) Applicant: The Kyjen Company, LLC, Centennial, CO (US)

(72) Inventors: Danielle Salyer, Denver, CO (US); Jeffrey Paris, Los Angeles, CA (US); Chaz Ozzello, Englewood, CO (US)

(21) Appl. No.: 19/080,601

(22) Filed: Mar. 14, 2025

Related U.S. Application Data
(60) Provisional application No. 63/565,874, filed on Mar. 15, 2024.

(51) Int. Cl. A01K 15/02

(52) U.S. Cl. CPC A01K 15/025

(57) ABSTRACT

A pet toy system includes a housing including a blower fan configured to blow air when in an on state and an air outlet pipe. The pet toy system also includes an interchangeable pet toy including a body having a movable element and an air inlet pipe configured to be removably coupled to the air outlet pipe of the housing. The movable element is configured to be moved by air when the blower fan is in the on state.

### CROSS-REFERENCE TO RELATED APPLICATION

This application claims the benefit of priority to U.S. Provisional Application entitled “Air Controlled Pet Toys,” filed on Mar. 15, 2024, and assigned Ser. No. 63/565,874, the entire disclosure of which is hereby expressly incorporated by reference.

### BACKGROUND OF THE DISCLOSURE

### Field of the Disclosure

The disclosure relates generally to pet toys, and more specifically, to interactive and interchangeable pet toys responsive to moving air.

### Brief Description of Related Technology

Generally, a wide variety of pet toys are available to keep pets entertained. For example, pet toys include chew toys which are typically comprised of durable materials such as rubber or nylon and are designed to withstand heavy chewing. Other pet toys include squeaky toys, designed to make noise entertaining pets; balls and frisbees, designed to entertain pets while encouraging exercise; plush toys; and the like. However, in addition to keeping pets entertained for extended periods, it is important to provide pets with mental stimulus in order to improve their overall health and behavior. Accordingly, there is a need for interactive pet toys that attract and mentally stimulate pets by attracting and keeping their attention. Additionally, there is a need for interactive pet toys that encourage the pet to engage with the toy again in the future.

### SUMMARY OF THE DISCLOSURE

In accordance with one aspect of the present disclosure, a pet toy system includes a housing including a blower fan configured to blow air when in an on state and an air outlet pipe. The pet toy system also includes an interchangeable pet toy including a body having a movable element and an air inlet pipe configured to be removably coupled to the air outlet pipe of the housing. The movable element is configured to be moved by air when the blower fan is in the on state.

In accordance with another aspect of the present disclosure, an interchangeable pet toy includes a body having a movable object and an inlet configured to receive moving air. The movable object is configured to be moved by the moving air when the moving air is received in the inlet.

In accordance with yet another aspect of the present disclosure, a modular pet toy system includes a fan configured to produce moving air when in an on state and a plurality of interchangeable pet toys. Each interchangeable pet toy of the plurality of interchangeable pet toys includes a body having a movable object and an inlet configured to be releasably attached to an outlet of the fan and configured to receive the moving air. The movable object is configured to be moved by the moving air when the moving air is received in the inlet.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 illustrates a perspective view of a pet toy system in accordance with one example of the present disclosure.

FIGS. 2A, 2B, and 2C illustrate a front view, a side view, and a back view, respectively, of a housing of the pet toy system of FIG. 1 in accordance with one example of the present disclosure.

FIG. 3 illustrates a top view of the housing of the pet toy system of FIG. 1 in accordance with one example of the present disclosure.

FIG. 4 illustrates a side view of the pet toy system of FIG. 1 showing the housing separated from the interchangeable pet toy with a cover of the housing removed in accordance with one example of the present disclosure.

FIG. 5 illustrates a perspective view of the air attachment of the pet toy system of FIG. 3 in accordance with one example of the present disclosure.

FIG. 6 illustrates a perspective view of the clip of the housing of FIG. 2 in accordance with one example of the present disclosure.

FIG. 7 illustrates a side view of the pet toy system of FIG. 1 in operation in accordance with one example of the present disclosure.

FIG. 8 illustrates a side view and a top view of the movable element of the pet toy system of FIG. 7 in accordance with one example of the present disclosure.

FIG. 9 illustrates a perspective view of a pet toy system in accordance with another example of the present disclosure.

FIGS. 10A, 10B, and 10C illustrate a modular pet toy system with three different interchangeable pet toys in accordance with one example of the present disclosure.

While the disclosed pet toys and pet toy systems are susceptible of embodiments in various forms, there are illustrated in the drawings (and will hereafter be described) specific embodiments of the disclosure, with the understanding that the disclosure is intended to be illustrative and is not intended to limit the disclosure to the specific embodiments described and illustrated herein.

### DETAILED DESCRIPTION OF THE DISCLOSURE

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those having ordinary skill in the art. Accordingly, known processes, elements, and techniques, may not be described with respect to some example embodiments. Unless otherwise noted, like reference characters denote like elements throughout the attached drawings and written description, and thus descriptions will not be repeated. The present disclosure, however, may be embodied in many alternate forms and should not be construed as limited to only the example embodiments set forth herein.

It should be understood that, although the terms first, second, etc. may be used herein to describe various elements, components, regions, levels, layers, and/or sections, these elements, components, regions, levels, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a device or apparatus that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

Spatial and functional relationships between elements are described using various terms, including “connected,” “engaged,” “interfaced,” “on,” and “coupled.” Unless explicitly described as being “direct,” when a relationship between first and second elements is described in the present disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, on, or coupled to another element, there are no intervening elements present. Other words used to describe the relationship between elements should be interpreted in a like fashion (e.g., “between,” versus “directly between,” “adjacent,” versus “directly adjacent,” and the like.).

For clarity of disclosure, the terms “proximal” (or “proximate”) and “distal” are defined herein relative to an item, such as a pet toy or product. The term “proximate” or “proximal” refers the position of an element closer to the item (pet toy or product). The term “distal” refers to the position of an element further away from the item. In addition, the terms “upper,” “lower,” “lateral,” “transverse,” “bottom,” “top,” are relative terms to provide additional clarity to the figure descriptions provided below. The terms “upper,” “lower,” “lateral,” “transverse,” “bottom,” “top,” are thus not intended to unnecessarily limit the technology or inventive concepts described herein.

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or”, and the like.

The present disclosure is provided to solve the above-mentioned problems in the Background of the Disclosure section. Specifically, the present disclosure provides a pet toy system that mentally stimulate pets by attracting and keeping their attention, thus encouraging the pet to engage with the toy again in the future.

The disclosed pet toy system generally includes a system of interchangeable or modular pet toys designed to use blown or forced air (or wind) to cause elements or objects within the pet toy to move, thereby enticing a pet to engage with the toy and hold the pet's attention. In one example, the pet toy system includes an air blower or fan to produce the blown or forced air (i.e., moving air), which can be attached to interchangeable pet toys with movable elements or objects therein. When the air blower or fan is turned on or running (i.e., an “on” state), the forced or moving air created by the air blower or fan is blown into the pet toy, moving or propelling items inside (or outside) the pet toy to move with the force of air. The movable elements or objects of the pet toy may be any number of things, such as balls, pieces of fabric (e.g., fabric animals, such as bugs or hamsters, or fabric figures). In this regard, the disclosed pet toy system involves air controlled or air induced pet toys that are interchangeable or modular, meaning they can be swapped out for each other in the system (i.e., the different pet toys can all be used with the same air blower or fan).

The disclosed innovative pet toy system engages many of the primary senses of a pet. Regarding visual stimulation, when the air blower or fan is turned on, the pet watches and observes the movable elements or objects move due to the forced/blown air or wind. Regarding auditory engagement, the movement of the movable elements or objects may create enticing sounds as they move (e.g., the sound of fabric pieces fluttering or rustling, the sound of small objects rattling around inside the pet toy, the sound of a ball rolling around a track, and the like). Regarding tactile exploration, the pet toys' designs encourage physical interaction, providing a satisfying sensory experience as the pet engages, manipulates and/or plays with the pet toys (e.g., using paws to bat a moving piece of fabric or a ball as they are blown around by forced air, swat at smaller objects dancing about in the moving air, or reach inside openings in the pet toys to try and grasp moving objects). To the extend food or treats are involved, olfactory and taste senses would also be engaged by allowing for pets to smell and taste the food or treats, which offers a tasty incentive for continued engagement. This multisensory approach ensures a comprehensive and stimulating experience for pets, promoting both mental and physical activity.

As mentioned above, the disclosed pet toy system involves a source of moving air and a plurality of interchangeable pet toys having movable items that are designed to be moved by the moving air. The movement of the items caused by the moving air entices a pet to engage and play with the pet toy for longer periods of time.

Although described below in connection with pet toys, the disclosed pet toy system may also be used in various other applications. For example, the disclosed pet toy system may be used as a toy system for young children, for example, toddlers, or babies.

Referring generally to the figures, a pet toy system according to the present disclosure may include a housing or control module and an interchangeable pet toy. The housing or control module may include an air blower unit (i.e., blower, air blower, blower fan, or fan) with an outlet (pipe, channel, conduit, duct, and the like). The interchangeable pet toy may include a body or casing containing one or more movable items, objects, or elements. The interchangeable pet toy may also include an inlet (pipe, channel, conduit, duct, and the like) designed and configured to be removably coupled or attached to the outlet of the housing or control module. As such, when the air blower or fan is turned on, the movable items of the pet toy are designed and configured to be moved by the moving air created by the air blower or fan, which attracts or lures a pet to engage and play with the pet toy. In other words, as air is forced into the pet toy, objects within the pet toy (or objects outside the pet toy, or the pet toy itself) are propelled about in a manner that attracts the attention of a pet and causes the pet to engage and play with the pet toy.

The housing or control module may include a power source, such as batteries, to power the blower or fan, as well as a mode assembly and speed control assembly to control various modes and speeds of the blower or fan. For example, different modes of play can be adjusted with a switch or dial, where some possible modes include a constant air mode, random burst mode (occasional and randomized gusts of air), fast/slow modes, and On/Off modes. In this way, a user (e.g., pet owner) can adjust the intensity of the air being blown into the pet toy. The housing or control module may also include a motion or heat sensor configured to detect motion or heat in order to control the power source, the mode assembly, and/or the speed control assembly. For example, the sensor may turn on or “wake up” the blower or fan when a pet walks near the housing or control module, or may turn off or “sleep” the blower or fan when a pet walks away from the housing or control unit and does not return for a certain period of time.

The outlet of the housing or control module may be designed and configured to allow easy interchangeability between different pet toys and the housing or control module. For instance, the outlet may include a clip or clip mechanism that allows for easy attachment and keeps the inlet of the pet toy attached to the outlet of the housing when the two are used together, but also allows for the easy disconnection and detachment of the pet toy from the housing when so desired. In one example, the disclosed pet toy system may also include an air attachment piece or component designed and configured to facilitate the coupling or attachment of the inlet of the pet toy to the outlet of the housing or control module and to direct the moving air from the blower or fan to the pet toy.

The pet toy may include a body having an enclosed portion that is at least partially transparent, thereby allowing a pet to see the movable objects, elements, or components disposed therein. In some cases, the body itself is the movable object. One example of an interchangeable air controlled pet toy includes a pet toy having a hollow plastic body that is designed and constructed to resemble a terrarium, where light fabric pieces resembling butterflies are caused to “flutter” around within the terrarium in response to air blown into the terrarium by the blower or fan. As the fabric butterflies rise and fall within the stream of air emitted by the blower or fan, they appear to be flying around within the terrarium. The hollow plastic body may be a globe or box-like structure, and may include an opening that allows a pet to insert a paw in order to attempt to grasp the fabric butterflies. Another example of an air induced pet toy is a ball track where the control unit (e.g., blower or fan) injects air and causes one or more light balls, such as ping pong balls, to spin, roll and travel around the track. There may be openings in the track that allow a pet to interact with, but not remove, the balls. Yet another example of an air controlled pet toy includes an “air dancer” or “tube dancer” similar to the inflatable advertisement at car dealerships, where the body of the pet toy includes a hollow piece of fabric such as nylon, where air forced into the body causes the figure to be filled with air, blown upright and wobble in multiple random directions and movements, creating dancing and waving motions. A character face, head or slips of fabric, feathers, and the like can be integrated into the figure.

A pet toy system in accordance with the present disclosure is configured to entertain a pet for a duration of time while the pet is attracted to and engages with the movable objects of the pet toys. A pet may simply stare and be mesmerized by the movement of the movable items or components. A pet may interact with the pet toy by swatting or biting the movable items in an attempt to grasp and capture the movable items by using, for example, their paws and/or mouth. A pet may also engage other components of the pet toy. As the pet engages the pet toy, the movable objects or components within or on the toy may continue to move around as long as moving air is being supplied to the pet toy.

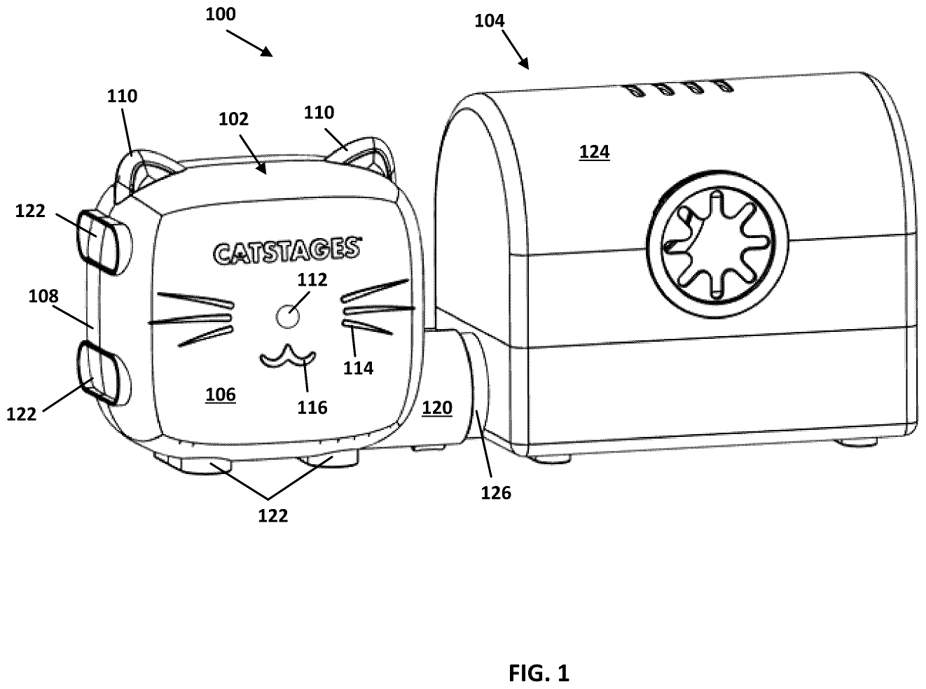

Referring generally to FIGS. 1-8, a pet toy system in accordance with one example of the present disclosure is illustrated. FIG. 1 illustrates a perspective view of a pet toy system in accordance with one example of the present disclosure. Referring to FIG. 1, the pet toy system 100 includes a housing 102 and an interchangeable pet toy 104. The housing 102 may be generally box shaped having a top, bottom, front, back, and two sides, and formed of two pieces or shells, such as a front shell 106 and back shell 108, but other shapes and designs are possible. In the example shown in the figures, the housing 102 includes design elements resembling a pet, such as a cat. For example, the housing 102 shown in the figures includes cat ear projections 110 on the top (e.g., top side or surface) of the housing 102 and cat facial features on the front (e.g., front surface or side) of the front shell 106, such as a nose 112, whiskers 114, and mouth 116.

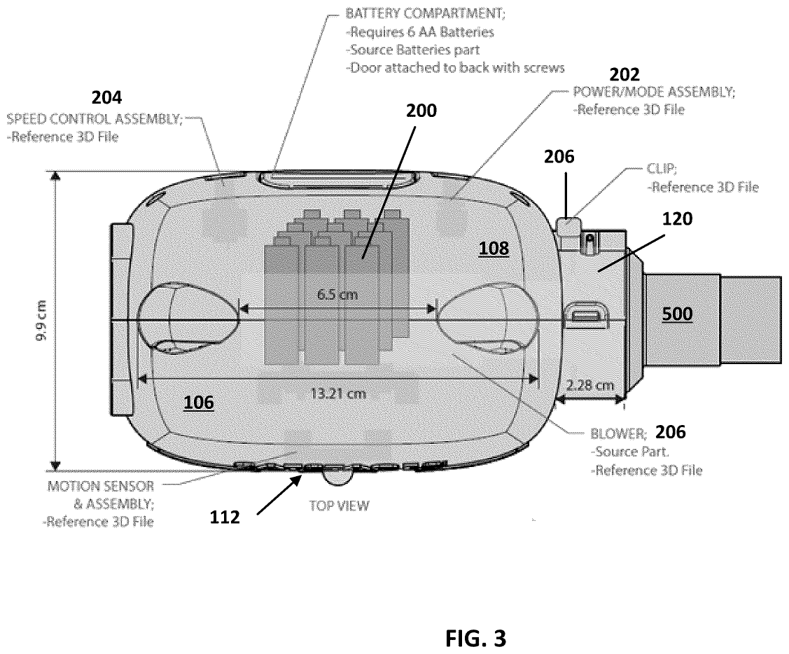

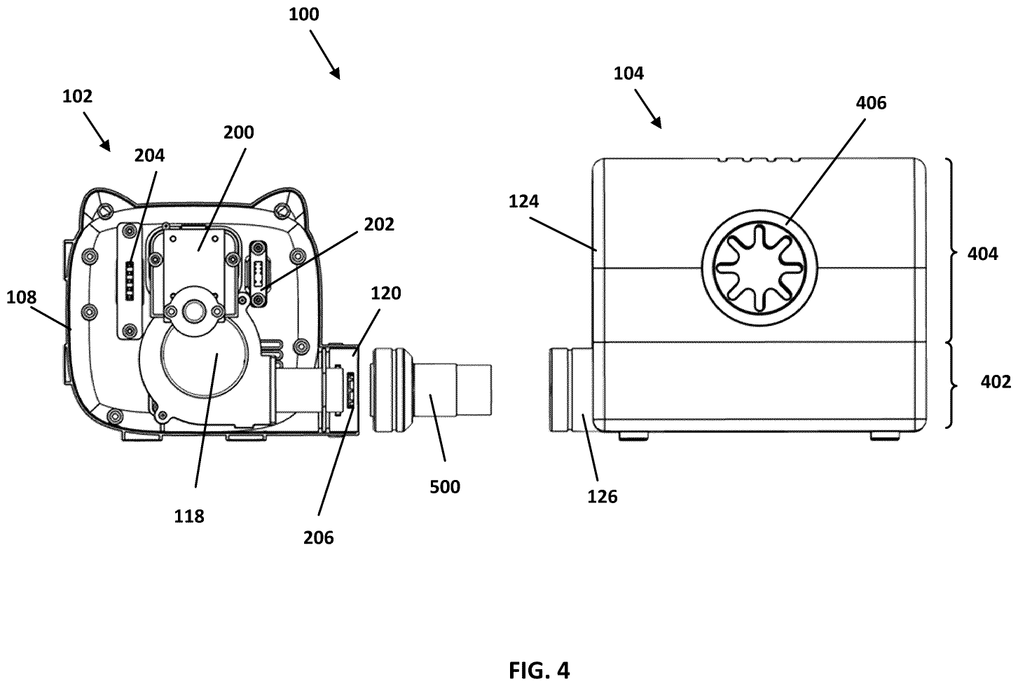

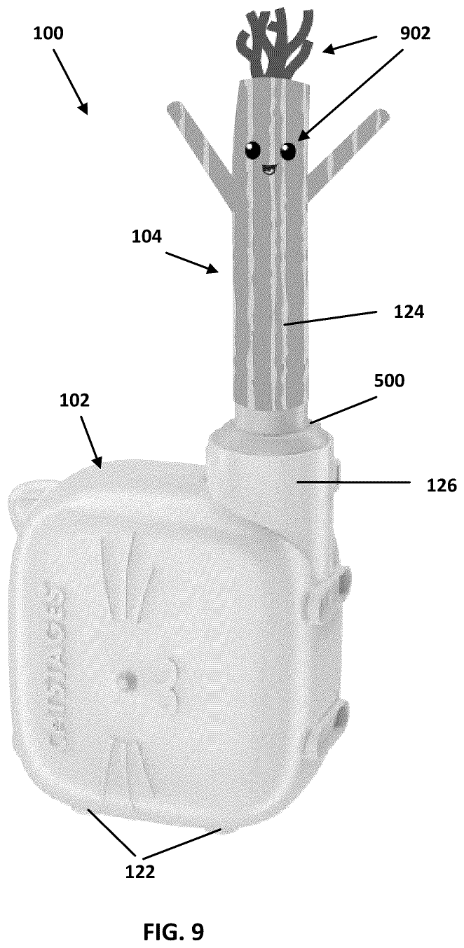

The housing 102 includes a blower fan 118 (also referred to herein as an air blower, blower, blower unit, fan, and the like) (not shown in FIG. 1—see FIGS. 3 and 4). The blower fan 118 is configured to blow air when in an on state (i.e., powered on and operational and not in a sleep mode). In one example, the blower fan 118 may be a brushless motor driven impeller fan, but other types of blowers and fans are possible. The housing 102 also includes an air outlet pipe 120 (channel, conduit, duct, and the like, but also referred to as simply an outlet). The air outlet pipe 120 is disposed on a proximal (relative to the pet toy 104) side of the housing 102, and more specifically on a lower portion of the proximal side of the housing 102. The housing 102 also includes support portions or feet 122 disposed on two sides of the housing 102, such as the bottom (e.g., bottom surface or side) of the housing 102 and a distal (relative to the pet toy 104) side (e.g., side surface) of the housing 102, the distal side opposite the proximal side and facing away from the pet toy 104. Having feet 122 on these two sides allows for multiple configurations of the housing 102. In a first configuration, such as that shown in FIG. 1, the housing 102 is resting on and supported by the feet 122 on the bottom of the housing 102. In a second configuration, such as that shown in FIG. 9, the housing 102 is resting on and supported by the feet 122 on the distal side of the housing 102. Each configuration allows for different types of pet toys 104 to be used, depending on a desired direction of forced air.

The interchangeable pet toy 104 includes a body 124 and an air inlet pipe 126 (channel, conduit, duct, and the like, but also referred to as simply an inlet). The body 124 includes at least one, or more than one, movable elements, items, components, or objects, as discussed in greater detail below. The air inlet pipe 126 is disposed on a side surface of the body 124 of the pet toy 104, the location corresponding to the location of the air outlet pipe 120 of the housing 102. The air inlet pipe 126 is configured to be removably or releasably coupled or attached to the air outlet pipe 120 of the housing 102, such that forced or blown air produced by the blower fan 118 exits the housing 102 through the air outlet pipe 120 and enters the pet toy 104 through the air inlet pipe 126 and is disbursed throughout an interior of the pet toy 104. As will be discussed in greater detail below, the movable element or object is configured to be moved by air when the blower fan 118 is in the on state. In this way, the pet toy 104 is an air controlled or air induced pet toy 104.

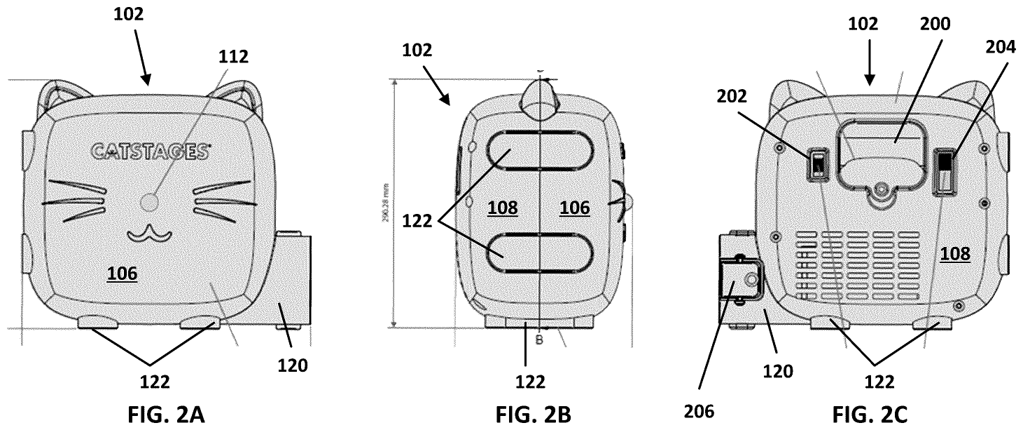

FIGS. 2A, 2B, and 2C illustrate a front view, a side view, and a back view, respectively, of the housing of the pet toy system of FIG. 1 in accordance with one example of the present disclosure. FIG. 2A illustrates a front view of the housing 102, showing the front panel 106. In one example, the nose 112 may be or include a sensor 112 configured to detect motion or heat and control an operation of the blower fan 118 based thereon. In one example, the sensor 112 is a motion sensor configured to detect a motion of a pet to control operation of the blower fan 118. In another example, the sensor 112 is a heat sensor configured to detect heat indicative of a pet nearby (i.e., a heat signature of a pet's body temperature, for instance). In either of these instances, if the blower fan is off or in a “sleep” mode, as a pet walks near the pet toy 104, the sensor 112 may detect motion or heat and send a signal to a printed circuit board (PCB) inside the housing 102, which in turn sends a signal to the blower fan 118 to turn on or “wake up” and begin operation (i.e., blowing air). Likewise, if the blower fan 118 is in an on state and the pet walks away, the sensor 112 may detect a lack of motion or lack of heat and send a signal to the PCB, which in turn sends a signal to the blower fan 118 to turn off or go to “sleep” and stop operation. In this way, the housing 102 is a “smart housing” that allows the housing 102 or control unit to conserve power.

FIG. 2B illustrates a side view of the housing 102, showing the feet 122 disposed on the distal side of the housing 102. The feet 122 are spaced apart on the distal side and span across the distal side, thus giving stability to the housing 102 when the housing 102 is resting on and supported by the feet 122 in the configuration shown in FIG. 9.

FIG. 2C illustrates a back view of the housing 102, showing the back panel 108. As shown in FIG. 2C, the back panel 108 of the housing 102 may include a power source 200, a mode assembly 202 (i.e., power/mode assembly or switch), and a speed control assembly 204 (i.e., speed control switch). As mentioned above, the housing 102 may also include a PCB, where the PCB is electrically connected to the power source 200, the mode assembly 202, the speed control assembly 204, the sensor 112 and the blower fan 118. The power source 200 is configured to power the blower fan 118, the sensor 112 and the PCB. The mode assembly 202 is configured to control a plurality of modes of the blower fan 118. For example, as mentioned above, the plurality of modes may include a constant air mode, a random burst mode (occasional and randomized gusts of air), fast/slow modes, and an On/Off mode. The speed control assembly 204 is configured to control the speed of the blower fan 118. Actuating the mode assembly 202 and the speed control assembly 204 triggers a signal to be sent to the PCB, which then sends a corresponding signal to the blower fan 118 to control the blower fan 118 according to the signals prompted by the actuation of the mode assembly 202 and the speed control assembly 204. In one embodiment, such as that shown in FIG. 2C, the mode assembly 202 and the speed control assembly 204 may both include a switch actuator. However, in another embodiment, each of the mode assembly 202 and the speed control assembly 204 may include a dial to adjust the modes and speeds. As discussed above, the sensor 112 may send signals to the PCB to control the blower fan 118 based on what the sensor 112 senses (i.e., motion or heat). In this way, the sensor 112 is configured to detect motion or heat (i.e., determine whether motion or heat is present) and control an operation of the blower fan 118 based thereon (i.e., based on the determination of whether motion or heat is present).

In one example, the power source 200 includes one or more batteries (behind the battery door shown in FIG. 2C—see FIG. 3). For instance, the power source 200 may include six (6) AA batteries, however, other number and types of batteries may be used, depending on the power demand. In some examples, rechargeable lithium ion (Li-ion) batteries may be used. As shown in FIG. 2C, the housing 102 may also include a vent portion to allow heat generated by the internal components of the housing 102, such as the blower fan 112 and PCB, to escape and allow outside air to circulate into the housing 102. The vent portion may also act as an intake for the blower fan 118 to draw in air.

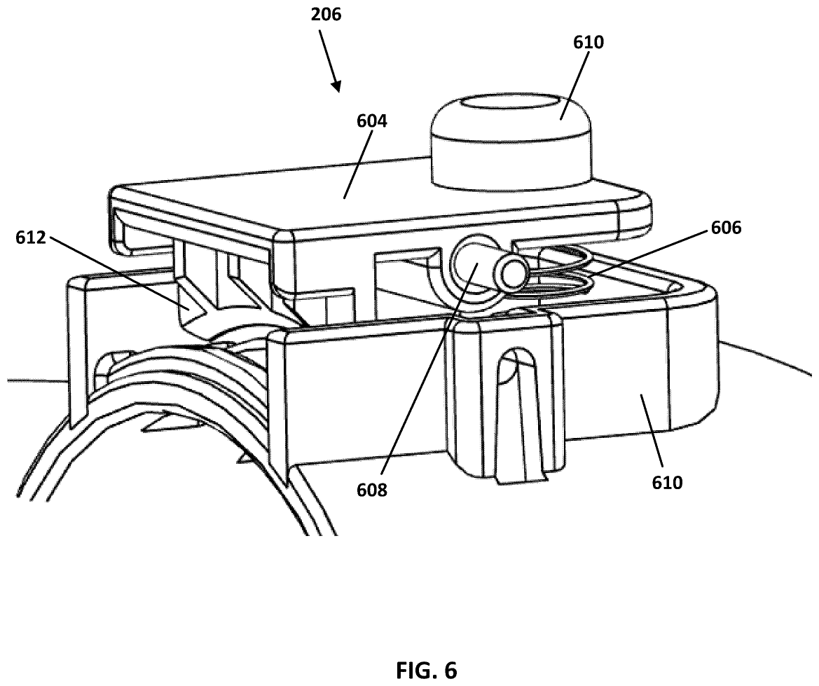

As shown in FIG. 2C, the air outlet pipe 120 of the housing 102 may also include a clip 206 or clip mechanism configured to releasably or removably engage the air inlet pipe 126 of the interchangeable pet toy 104 to the air outlet pipe 120 of the housing 102. The clip 206 is described below in more detail with reference to FIG. 6. The clip 206 provides for easy attachment of various interchangeable pet toys 104 and keeps the air inlet pipe 126 of the pet toy 104 attached to the air outlet pipe 120 of the housing 102 when the two are used together, but also allows for the easy disconnection and detachment of the pet toy 104 from the housing 102 when so desired. The ease of having a quick release mechanism such as the clip 206 described below is advantageous for interchangeable and modular systems such as those described and disclosed herein.

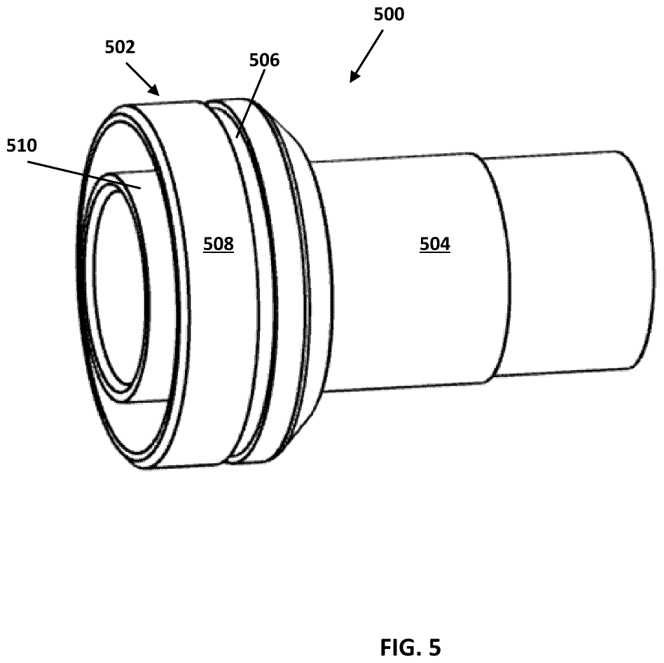

FIG. 3 illustrates a top view of the housing of the pet toy system of FIG. 1 in accordance with one example of the present disclosure. FIG. 3 shows the internal placement and spacing of the components of the housing 102, including the power source 200 (e.g., plurality of AA batteries), blower fan 118, sensor 112 (and internal sensor assembly), the mode assembly 202 and the speed control assembly 204. FIG. 3 also shows an air attachment 500 inserted into the air outlet pipe 120, which is described in more detail below with reference to FIGS. 4 and 5.

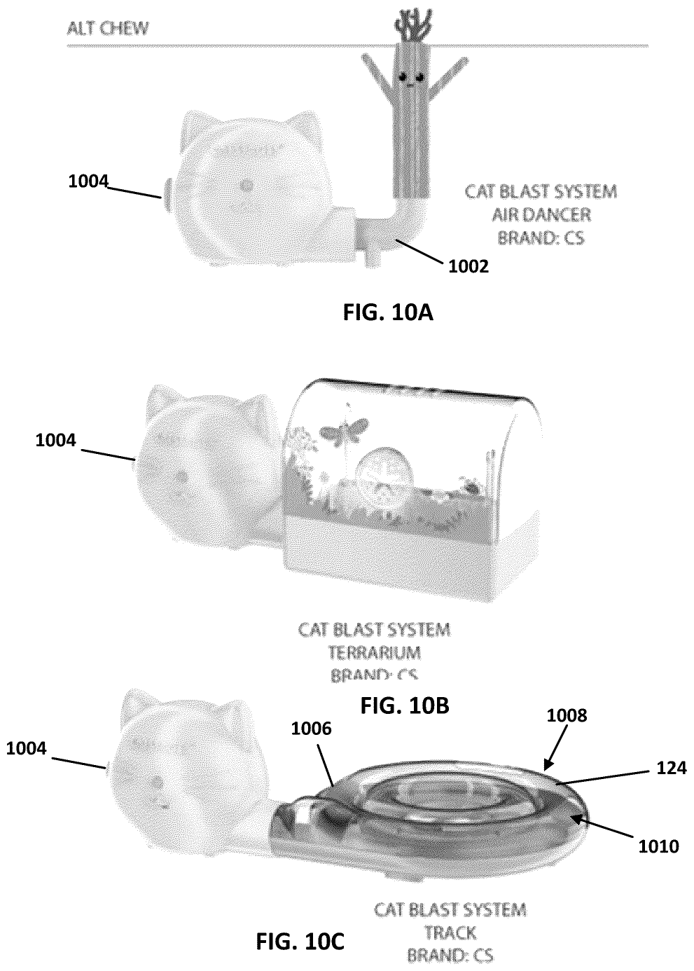

Referring to FIG. 4, FIG. 4 illustrates a side view of the pet toy system of FIG. 1 showing the housing 102 separated from the interchangeable pet toy 104 with a cover of the housing removed in accordance with one example of the present disclosure. As shown in FIG. 4, the front shell 106 of the housing 102 is removed, showing the internal components of the housing 102, such as the blower fan 118, the power source 200, the mode assembly 202 and the speed control assembly 204. As shown in FIGS. 1, 4, and 10B, the body 124 of the interchangeable pet toy 104 is generally box shaped having a quadrilateral longitudinal cross section, such as a rectangle or square base 402, and a top or cover portion 404 (cover). The cover 404 may have a longitudinal cross section that matches that of the base 402, since the cover 404 is removably attached to the base 402. The upper part or top surface of the cover 404 may be rounded, and have a generally U-shaped or horseshoe-shaped transverse cross sectional shape (see FIGS. 1 and 10B). However, other shapes of the base 402 and cover 404 are possible. For example, the body 124 of the pet toy 104 may also be generally globe shaped, having a circular cross sectional shape (both transverse and longitudinal).

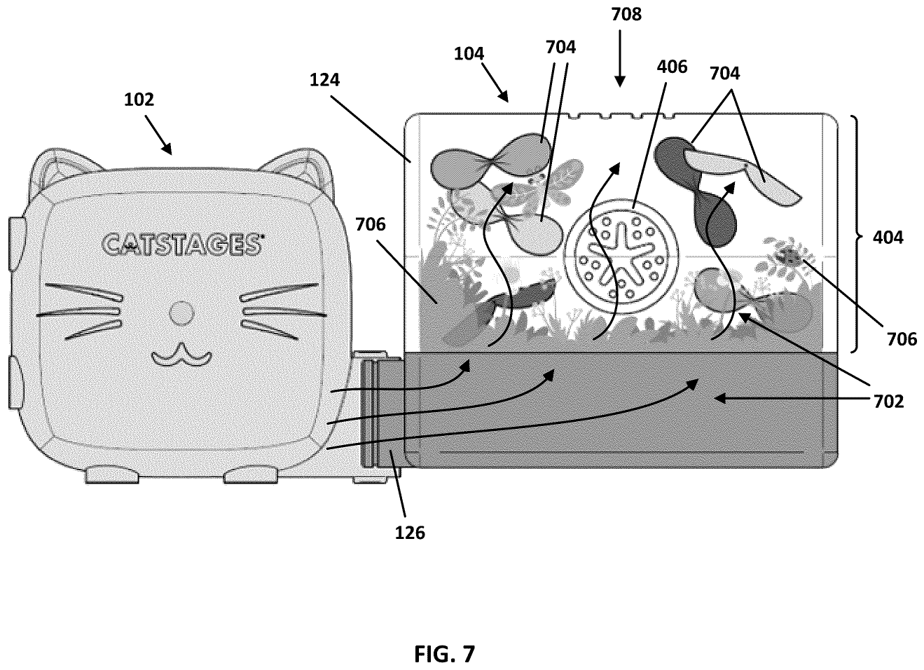

The cover 404 of the body 124 of the pet toy 104 is generally hollow, such that when the cover 404 is placed and secured to the base 402 (via screws, snap fit, and the like), the cover 404 creates an enclosed area or space within (i.e., under) the cover 404. In some examples, the cover 404 may also be referred to as the enclosed portion of the body 124 of the pet toy 104. In other examples, the combination of the base 402 and the cover 404 may be referred to as the enclosed portion, since the base 402, or a portion thereof, may also be hollow or have a cavity or interior space therein. The movable elements or objects can be disposed within this enclosed portion. In one example, the cover 404 is transparent, allowing the interior space under the cover 404 to be seen from outside the cover 404 (see FIGS. 7 and 10B). In this way, a pet is able to see contents of the pet toy 104, such as the movable objects or elements, as discussed in greater detail below. As such, the body 124 of the pet toy 104 is at least partially transparent. In another example, the body 124 of the pet toy 104 may be fully transparent, where the base 402 and the cover 404 are both transparent.

The cover 404 may also include a cover opening 406. In the example shown in the figures, the cover opening 406 is circular shaped and disposed on a sidewall of the cover 404. Other shapes and positions are possible. The cover opening 406 is designed and configured to allow a pet to insert a paw into the cover 404 to attempt to grab or capture the movable elements or objects therein. Size and shape considerations are taken into account to allow a pet's paw to be easily inserted and removed through the cover opening 406 without harm to the pet. In one example, flexible tabs or flaps can be disposed along the inner circumference or perimeter of the cover opening 404 to reduce the area of the cover opening 406 in which a pet can insert their paw. In this way, the flexible tabs or flaps deter pets from inserting a body part into the cover opening 406 that may not fit, thus reducing the chances of a pet getting stuck or caught in the cover opening 406.

In one example, as mentioned above with regard to FIG. 3, the pet toy system 100 also includes an air attachment 500 disposed between the air outlet pipe 120 and the air inlet pipe 126. In one example, the air attachment 500 is configured to couple the air inlet pipe 126 of the interchangeable pet toy 104 to the air outlet pipe 120 of the housing 102 (and thus the outlet of the blower fan 118). In this example, the air attachment 500 is also configured to direct the moving air (i.e., the blown or forced air produced by the blower fan 118) from the blower fan 118 to the body 124 of the interchangeable pet toy 104. The air attachment 500 is described in more detail below with reference to FIG. 5. In general, the air attachment 500 is nozzle shaped, having a cylindrical head portion and cylindrical tube portion. The head portion is sized and configured to correspond to the size and shape of the air outlet pipe 120 of the housing 102, as well as the size and shape of the air inlet pipe 126 of the interchangeable pet toy 104. For example, the air inlet pipe 126 is configured to fit over the head portion of the air attachment 500, and both the air inlet pipe 126 and the air attachment 500 are configured to fit within the air outlet pipe 120. In this regard, the diameter of the air outlet pipe 120 is slightly larger than the diameter of the air inlet pipe 126, and the diameter of the air inlet pipe 126 is slightly larger than the diameter of the head portion of the air attachment 500. As shown in FIG. 4, each of the head portion of the air attachment 500 and the air inlet pipe 126 have a groove, slot, notch, or detent around an outside perimeter wall configured to receive a latch of the clip mechanism 206 to retain the components in a coupled or attached configuration, as discussed below. The cylindrical tube portion of the air attachment 500 has a smaller diameter than the head portion, and when the pet toy 104 and housing 102 are attached at their respective inlet/outlet, the tube portion fits within and extends into the base 402 of the pet toy 104. This allows the forced or blown air created by the blower fan 118 to be directed into the pet toy 104 is a more controlled and evenly dispersed manner. In another embodiment, the air attachment 500 may not be used and the air inlet pipe 126 of the pet toy 104 may be directly coupled or attached to the air outlet pipe 120 of the housing 102. In some examples, as discussed below, the air attachment 500 may be used for certain pet toys 104 that do not have an inlet like the air inlet pipe 126 of the pet toy 104 of FIG. 4. An example of this is shown in FIG. 9.

FIG. 5 illustrates a perspective view of the air attachment of the pet toy system of FIG. 3 in accordance with one example of the present disclosure. As mentioned above, and as shown in FIG. 5, the air attachment 500 is nozzle shaped and includes a cylindrical head 502 (or head portion) and cylindrical tube 504 (or tube portion) extending away from the head 502. The tube 504 may taper or neck down in any number of steps, even though only two are shown in FIG. 5. The tapered or necked down end of the air attachment 500 may be shaped based on an inlet of a corresponding toy and be configured to attach to that corresponding toy, such as that shown in FIG. 9. The head 502 may include an outer wall 508 and an inner wall 510 disposed within and spaced apart from the outer wall 508, such that the walls 508, 510 are concentric. In one example, the inner wall 510 may be an extension of the tube 504, such that the head 502 includes only the outer wall 508 surrounding an end of the tube 504. As discussed above, the head 502 of the air attachment 500 may also include a notch 506 (i.e., groove, slot, or detent) formed in and around the outer wall 508. The notch 506 is configured to receive a latch of the clip mechanism 206 to retain the air attachment 500 in a coupled or attached configuration with the air outlet pipe 120 of the housing 102. In other words, when the air attachment 500 is inserted into the air outlet pipe 120 of the housing 102, the notch 506 aligns with the latch, described below, to hold the air attachment 500 in place within the air outlet pipe 120 until released.

FIG. 6 illustrates a perspective view of the clip of the housing of FIG. 2 in accordance with one example of the present disclosure. As shown in FIG. 6, the clip 206 (or clip mechanism) is a spring biased clip or clamp that includes a clip housing 602, a clip body 604, a spring 606 disposed between the clip housing 602 and the clip body 604, and a pivot rod 608 coupling the clip body 604 to the clip housing 602. The clip body 604 includes a knob or button 610 extending away from the clip body 604 in a direction away from the air outlet pipe 120 of the housing 102. The button 610 is disposed on an outer surface of the clip body 604 at a location opposite from the location of the spring 606, such that pushing downward on the button 610 depresses the spring 606. The clip body 604 also includes a latch 612 (i.e., finger portion, retaining lateral extension, and the like) extending away from the clip body 604 in a direction opposite the direction in which the button 610 extends. In other words, the latch 612 extends away from the clip body 604 in a direction towards the air outlet pipe 120 of the housing 102. The latch 612 is located at an end or side of the clip body 604 opposite the button 610, such that as the button 610 moves in one direction, the latch 612 moves in an opposite direction. The end of the latch 612 distal to the clip body 604 is tapered or beveled and has an arc shape that corresponds to the shape or curvature of the outer wall 508 of the head 502 of the air attachment 500.

The operation of the latch 612 is described below. In describing directions of components, terms such as “upward” or “downward” refer to the orientation shown in FIG. 6. In this case, the term “upward” means away from the air outlet pipe 120 and the term “downward” means toward the air outlet pipe 120. As the head 502 of the air attachment 500 is inserted into the air outlet pipe 120 of the housing 102, the end of the outer wall 508 contacts the tapered or beveled end of the latch 612, thus forcing the latch 612 upward. As the latch 612 moves upward, the opposite side of the clip body 604 (i.e., opposite the pivot 608) having the button 610 moves downward and compresses the spring 606, which puts the clip body 604 under a tension or spring force. When the head 502 of the air attachment 500 is inserted far enough into the air outlet pipe 120 such that the notch 506 is positioned and aligned with the position of the latch 612, the tapered or beveled end of the latch 612 is forced into the notch 506 by the spring force that the clip body 604 is under due to the spring 606 being depressed. As the latch 612 drops into the notch 506, the arc shaped end of the latch 612 abuts the curved notch surface. In this configuration, the air attachment 500 is not able to be removed from the air outlet pipe 120 since the latch 612 being in the notch 506 prohibits movement of the air attachment 500. To release the air attachment 500, a user depresses the button 610, which compresses the spring 606. As the side of the clip body 604 having the button 610 moves downward, the other side of the clip body 604 opposite the pivot 608 moves upward, which moves the latch 612 out of the notch 506, thus allowing the air attachment 500 to be removed from the air outlet pipe 120.

While the operation of the clip 206 described above was directed to the air attachment 500 being inserted into the air outlet pipe 120 of the housing 102, the same operation would apply to when the air inlet pipe 126 of the pet toy 104 is directly inserted into the air outlet pipe 120 of the housing 102 without the air attachment 500. The disclosed quick release clip mechanism 206 allows for quick and easy attachment and detachment of any pet toy having the same design and configuration as the air inlet pipe 126 of the pet toy 104 or the air attachment 500 described above, which allows for interchangeability and modularity of various pet toys using the same housing 102.

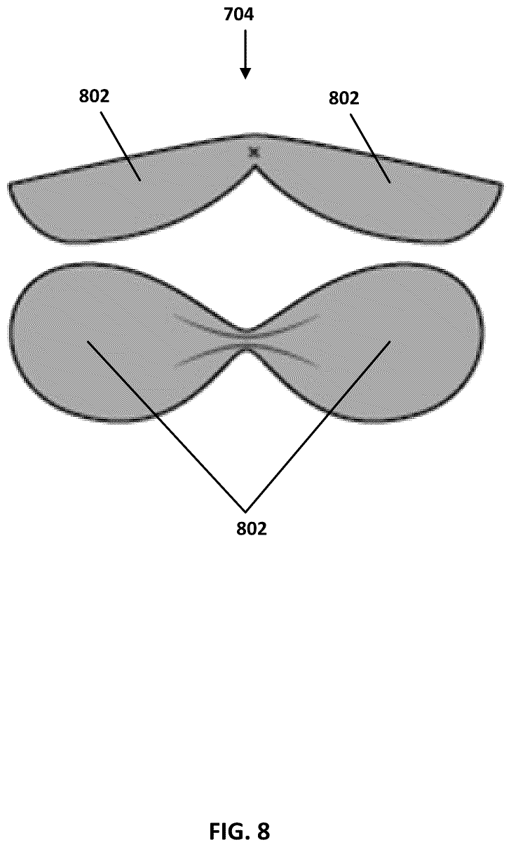

FIG. 7 illustrates a side view of the pet toy system of FIG. 1 in operation in accordance with one example of the present disclosure. FIG. 7 shows one example of an interchangeable pet toy 104 described above as having a hollow plastic body 124 that is designed and constructed to resemble a terrarium. In this example, the body 124 of the pet toy 104 includes an enclosed portion 404 (i.e., cover, such as cover 404 described above) that is at least partially transparent. In this example, the pet toy 104 includes a generally globe or box-like structure. FIG. 7 depicts the blower fan 118 in operation, creating moving air 702 that moves from the blower fan 118 through the air inlet pipe 126, into the base 402 of the pet toy 104, and up into the enclosed portion 404 of the body 124 of the pet toy 104. As shown in FIG. 7, the body 124 of the pet toy 104 includes movable elements 704 disposed within the enclosed portion 404. Any number of movable elements 704 may be used. In this example, as shown in FIGS. 7 and 8, the movable elements 704 include light pieces of fabric resembling butterflies, such that when the blower fan 118 is in the on state, the pieces of fabric (i.e., the movable elements 704) are configured to be moved by air 702 within the globe or box-like structure of the body 124 of the pet toy 104. The moving air 702 causes the movable elements 704 to “flutter” around within the enclosed portion 404 of the body 124 of the pet toy 104 (i.e., the “terrarium”) in response to air 702 blown into the terrarium by the blower fan 118. As the fabric butterflies (the movable elements 704) rise and fall within the stream of air 702 emitted by the blower fan 118, they appear to be flying around within the terrarium. As described above, the body 124 of the pet toy 104 may include an opening 406 that allows a pet to insert a paw in order to attempt to grasp the movable elements 704. The transparent portion of the body 124 of the pet toy 104 may also include graphics or stickers 706 to have the pet toy 104 further resemble a terrarium. For example, the stickers 706 may include images of grass, weeds, flowers, insects, butterflies, and the like, to attract and entice a pet. The body 124 of the pet toy 104 may also include vents 708 allowing for proper pressurization and circulation of the moving air 702. In the example shown in FIG. 7, the vents 708 are located at the top of the body 124, but the vents 708 can be located in other various locations as well. The base 402 of the pet toy 104 may also include a screen cover (not shown) disposed at the intersection of the base 402 and the air inlet pipe 126. The screen cover may prevent movable elements 704 from traveling into the housing 102, which may damage the blower fan 118.

FIG. 8 illustrates a side view and a top view of the movable element of the pet toy system of FIG. 7 in accordance with one example of the present disclosure. As discussed above, the movable elements 704 in one example include light pieces of fabric designed and configured to be moved by moving air 702. In the example shown in FIGS. 7 and 8, the movable elements 704 include wings 802 to resemble butterflies or other flying insects. The wings 802 may be cupped or bowl-like, such that air is captured in the wings 802 causing the movable elements 704 to rise inside the body 124 of the pet toy 104 during operation of the blower fan 118. The movable elements 704 may be made by cutting and sewing fabric, by stitching them in the center to create the wing-like appearance. The movable elements 704, or just the wings 802, may be any color or combinations of colors to attract a pet. The materials used to construct the movable elements 704 may include a lightweight material, such as mylar or woven fabric. Materials too heavy may impair the functionality of the movable elements 704, since they may not be movable by the moving air 702 if they are too heavy.

FIG. 9 illustrates a perspective view of a pet toy system in accordance with another example of the present disclosure. FIG. 9 shows a pet toy system 100 where the housing 102 in a different configuration than that described above. In the configuration shown in FIG. 9, the housing 102 is resting on and supported by the feet 122 on the distal side of the housing 102, such that the air inlet pipe 126 is pointing upward (i.e., vertically). The body 124 of the pet toy 104 is different than that described above as well. In the example shown in FIG. 9, the body 124 of the pet toy 104 is designed and configured to resemble an “air dancer” or “tube dancer,” where the body 124 of the pet toy 104 includes a hollow piece of fabric such as nylon or polyester, where air forced into the body causes the figure to be filled with air, blown upright and wobble in multiple random directions and movements, creating dancing and waving motions. In other words, at least a portion of the body 124 of the interchangeable pet toy 104 includes a hollow piece of fabric. In this case, the movable element includes a portion of the hollow piece of fabric, such that when the blower fan 118 is in the on state, the portion of the hollow piece of fabric is configured to be moved by air blown by the blower fan 118 flowing through the portion of the hollow piece of fabric. In one example, the body 124 of the pet toy 104 may include additional features 902, such as a character face, head or slips of fabric, feathers, and the like that can be attached to or integrated into the body 124 of the pet toy 104, which further attract and entertain a pet.

As shown in FIG. 9, the air attachment 500 is inserted into the air inlet pipe 126 of the housing 102. Specifically, the head 502 of the air attachment 500 nested within the air inlet pipe 126 and the tube 504 of the air attachment 500 is coupled to the body 124 of the pet toy 104. More specifically, the necked down or tapered portion of the tube 504 of the air attachment 500 may be coupled to the body 124 of the pet toy 104.

In the embodiments described herein, an interchangeable pet toy includes a body having a movable object and an inlet configured to receive moving air, where the movable object is configured to be moved by the moving air when the moving air is received in the inlet. In one example, the inlet is further configured to be removably attached to an outlet of a fan to receive the moving air. The concept disclosed herein contemplates various types of interchangeable pet toys, any number of which may be used with the disclosed pet toy systems.

FIGS. 10A, 10B, and 10C illustrate a modular pet toy system with three different interchangeable pet toys in accordance with one example of the present disclosure. FIG. 10A depicts an example pet toy system similar to that shown and described with respect to FIG. 9 (i.e., the “air dancer” embodiment). The example shown in FIG. 10A differs from the example of FIG. 9 in that the housing is resting on and supported by a different set of feet, similar to the example of FIG. 1. With the housing in this configuration, a different air attachment is used. As shown in FIG. 10A, the air attachment is an elbow-shaped air attachment 1002 that allows the outlet of the housing to be orientated horizontally, while the pet toy is orientated vertically. The housing of FIG. 10A also includes a dial 1004 on the left side (with respect to the view shown in FIG. 10A) to control the air output (i.e., to control the functions of the blower or fan). FIG. 10B depicts an example pet toy system similar to that shown and described with respect to FIGS. 1, 2, 4 and 7 (i.e., the “terrarium” embodiment). Similar to FIG. 10A above, the housing of FIG. 10B also includes an air control dial 1004 as opposed to the mode and control assemblies 202, 204 described above.

FIG. 10C illustrates another example of an interchangeable or modular pet toy system. The housing of FIG. 10C is the same as those described above for FIGS. 10A and 10B, including the air control dial 1004 as opposed to the mode and control assemblies 202, 204 described above. However, in the example shown in FIG. 10C, the pet toy 104 is different. In the example shown in FIG. 10C, the control unit (e.g., blower or fan) injects air and causes one or more light balls 1006, such as ping pong balls, to spin, roll and travel around a track 1008. In other words, the enclosed portion of the body 124 of the interchangeable pet toy includes a track 1008, where the movable element comprises a ball 1006, such that when the blower fan is in the on state, the ball 1006 is configured to be moved by air within the track 1008. In one example, the track 1008 may include track openings 1010 that allow a pet to interact with, but not remove, the ball 1006. In the example shown in FIG. 10C, only one ball 1006 is shown. However, more than one ball 1006 may be used.

The embodiments shown and described herein illustrate a modular pet toy system. The modular pet toy system includes a fan configured to produce moving air when in an on state and a plurality of interchangeable pet toys. Each interchangeable pet toy of the plurality of interchangeable pet toys includes a body having a movable object and an inlet configured to be releasably attached to an outlet of the fan and configured to receive the moving air. The movable object is configured to be moved by the moving air when the moving air is received in the inlet. Each interchangeable pet toy of the plurality of interchangeable pet toys is selectable and removably attachable to the fan. The movable object includes an attractant or lure configured to entice a pet to play when the movable object is moved by the moving air. While only some examples of interchangeable pet toys have been shown and described herein, other pet toys having the same or similar parts or components described herein that allow an object to move using forced or controlled air are contemplated. Thus, the disclosure pertains to various versions, now known or later developed, of air controlled pet toys.

In one example, certain components of the disclosed pet toy or pet toy system, such as the housing and the body of the pet toy, may be comprised of a thermoplastic elastomer (TPE). For example, one or more of the housing or body of the pet toy may be comprised of styrenic block copolymers, thermoplastic polyolefin elastomers, thermoplastic vulcanizates, thermoplastic polyurethanes, thermoplastic copolyester, thermoplastic polyamides, or the like. In other examples, one or more of the housing or body of the pet toy may be comprised of thermoplastic rubber (TPR), thermoplastic polyurethane (TPU), polyvinyl chloride (PVC), rubber, polypropylene (PP), acrylonitrile butadiene styrene (ABS), low density polyethylene (LDPE), or high density polyethylene (HDPE). Other suitable materials, now known or later developed, may also be used.

The present disclosure provides pet toys that are responsive to moving air created by a blower or fan, and where the blower or fan is interchangeable with multiple different pet toys. The disclosed modular toy system described herein allows for many different toys to be interchanged with the blower or fan. For example, any toys with the same type of inlet and connection components described herein can be interchanged with the outlet of the blower or fan. In this way, a single blower or fan can be used and interchanged between various products. Having the ability to modularize toys, such as those shown and described herein, with a single control module such as a blower or fan allows variation and added fun to keep pets engaged for longer periods of time.

While the present disclosure has been described with reference to specific examples, which are intended to be illustrative only and not to be limiting of the disclosure, it will be apparent to those of ordinary skill in the art that changes, additions and/or deletions may be made to the disclosed embodiments without departing from the spirit and scope of the disclosure.

The foregoing description is given for clarity of understanding only, and no unnecessary limitations should be understood therefrom, as modifications within the scope of the disclosure may be apparent to those having ordinary skill in the art.

When a component, device, element, or the like of the present disclosure is described as having a purpose or performing an operation, function, or the like, the component, device, or element, should be considered herein as being “configured to” meet that purpose or perform that operation or function.

What is claimed is:

1. A pet toy system comprising:
a housing including:
a blower fan configured to blow air when in an on state; and
an air outlet pipe; and
an interchangeable pet toy including:
a body having a movable element; and
an air inlet pipe configured to be removably coupled to the air outlet pipe of the housing,
wherein the movable element is configured to be moved by air when the blower fan is in the on state.

2. The pet toy system of claim 1, wherein the housing further comprises:
a power source configured to power the blower fan;
a mode assembly configured to control a plurality of modes of the blower fan; and
a speed control assembly configured to control the speed of the blower fan.

3. The pet toy system of claim 2, wherein the plurality of modes of the blower fan includes a fast mode, a slow mode, and a random burst mode.

4. The pet toy system of claim 2, wherein the power source comprises one or more batteries.

5. The pet toy system of claim 1, wherein the housing further comprises a motion sensor configured to detect motion and control an operation of the blower fan based thereon.

6. The pet toy system of claim 1, wherein the air outlet pipe of the housing comprises a clip mechanism configured to releasably engage the air inlet pipe of the interchangeable pet toy to the air outlet pipe of the housing.

7. The pet toy system of claim 1, wherein the body of the interchangeable pet toy is at least partially transparent and includes an enclosed portion, and wherein the movable element is disposed within the enclosed portion.

8. The pet toy system of claim 7, wherein the enclosed portion of the body of the interchangeable pet toy includes a globe or box-like structure and wherein the movable element comprises a piece of fabric, such that when the blower fan is in the on state, the piece of fabric is configured to be moved by air within the globe or box-like structure.

9. The pet toy system of claim 7, wherein the enclosed portion of the body of the interchangeable pet toy includes a track and wherein the movable element comprises a ball, such that when the blower fan is in the on state, the ball is configured to be moved by air within the track.

10. The pet toy system of claim 1, wherein at least a portion of the body of the interchangeable pet toy comprises a hollow piece of fabric, and wherein the movable element includes a portion of the hollow piece of fabric, such that when the blower fan is in the on state, the portion of the hollow piece of fabric is configured to be moved by air blown by the blower fan flowing through the portion of the hollow piece of fabric.

11. An interchangeable pet toy comprising:
a body having a movable object; and
an inlet configured to receive moving air,
wherein the movable object is configured to be moved by the moving air when the moving air is received in the inlet.

12. The interchangeable pet toy of claim 11, wherein the body of the interchangeable pet toy is at least partially transparent and includes an enclosed portion, and wherein the movable object is disposed within the enclosed portion.

13. The interchangeable pet toy of claim 12, wherein the enclosed portion of the body of the interchangeable pet toy includes a globe or box-like structure and wherein the movable object comprises a piece of fabric, such that when the moving air is received in the inlet, the piece of fabric is configured to be moved by the moving air within the globe or box-like structure.

14. The interchangeable pet toy of claim 12, wherein the enclosed portion of the body of the interchangeable pet toy includes a track and wherein the movable object comprises a ball, such that when the moving air is received in the inlet, the ball is configured to be moved by the moving air within the track.

15. The interchangeable pet toy of claim 11, wherein at least a portion of the body of the interchangeable pet toy comprises a hollow piece of fabric, and wherein the movable object includes a portion of the hollow piece of fabric, such that when the moving air is received in the inlet, the portion of the hollow piece of fabric is configured to be moved by the moving air flowing through the portion of the hollow piece of fabric.

16. The interchangeable pet toy of claim 11, wherein the inlet is further configured to be removably attached to an outlet of a fan to receive the moving air.

17. The interchangeable pet toy of claim 16, wherein the fan comprises a motion sensor configured to detect motion and control an operation of the fan based thereon.

18. The interchangeable pet toy of claim 16, further comprising an air attachment configured to couple the inlet of the interchangeable pet toy to the outlet of the fan and to direct the moving air from the fan to the body of the interchangeable pet toy.

19. A modular pet toy system comprising:
a fan configured to produce moving air when in an on state, the fan including an outlet; and
a plurality of interchangeable pet toys, each interchangeable pet toy of the plurality of interchangeable pet toys including:
a body having a movable object; and
an inlet configured to be releasably attached to the outlet of the fan and configured to receive the moving air,
wherein the movable object is configured to be moved by the moving air when the moving air is received in the inlet.

20. The modular pet toy system of claim 19, wherein each interchangeable pet toy of the plurality of interchangeable pet toys is selectable and removably attachable to the fan, and wherein the movable object comprises an attractant or lure configured to entice a pet to play when the movable object is moved by the moving air.
